(19) United States
(12) Patent Application Publication
(10) Pub. No.: US 2014/0041241 A1
(43) Pub. Date: Feb. 13, 2014

(54) OPTICAL LEVELING SYSTEM AND METHOD

(71) Applicants: Alma Jaze, Astoria, NY (US); Alan H. Knight, Cary, NC (US); Simon Mathew, Middletown, NY (US); Kwok M. Soo Hoo, Lagrangeville, NY (US)

(72) Inventors: Alma Jaze, Astoria, NY (US); Alan H. Knight, Cary, NC (US); Simon Mathew, Middletown, NY (US); Kwok M. Soo Hoo, Lagrangeville, NY (US)

(73) Assignee: International Business Machines Corporation, Armonk, NY (US)

(21) Appl. No.: 13/570,354

(22) Filed: Aug. 9, 2012

(51) Int. Cl. G01C 9/12

(52) U.S. Cl. 33/301; 33/365

(57) ABSTRACT

Aspects of the present invention provide an optical leveling system and method. Embodiments of the present invention utilize a pendulum having an opening through which light can pass to create varying light patterns in response to movement of the pendulum relative to an enclosure. The varying light patterns are detected and utilized to determine the position of the pendulum relative to the enclosure, which can be expressed as degrees and increments of degrees of deviation from a level condition. Embodiments of the present invention can be utilized, for example, to remotely monitor whether a mainframe computer system is level and, if necessary, alert service personnel.

### FIELD OF THE INVENTION

The present invention relates generally to leveling systems and, more particularly, to optical leveling systems.

### BACKGROUND

Mainframe computer system environments often involve many sensitive electronic devices within close proximity to one another. To ensure the electromagnetic compatibility (EMC) of the electronic devices, various measures can be employed to suppress electromagnetic interference (EMI) emissions and reduce the susceptibility of the electronic devices to external EMI and other electrical events. One measure involves the use of conductive EMC gaskets. For example, EMC gaskets can be deployed between a chassis and a chassis cover, between input/output (I/O) drawers, and between various other components and compartments in the system to prevent EMI leakage through gaps at these junctures.

Proper leveling of a mainframe chassis is an important consideration for the efficacy of EMC gaskets and overall system reliability. Typically, EMC gaskets must be compressed uniformly and within a certain compression range for optimal protection against EMI leakage. Improper leveling of a mainframe chassis can result in chassis warping, which can cause compression variations along EMC gaskets and result in EMI leakage. Connections that involve tight tolerances can also be affected by chassis warping. For example, connector pins can be bent during installation or can become susceptible to intermittent pin contact issues. In addition, improper leveling can increase vibration in rotary devices such as fans and hard disk drives, which can decrease the reliability of these devices.

### SUMMARY

According to one aspect of the present invention, there is provided an optical leveling system comprising: a pendulum disposed within an enclosure, the pendulum pivotally coupled to the enclosure for enabling pivoted movement of the pendulum relative to the enclosure, the pendulum having an opening through which light can pass to create patterns of light that vary in response to the pivoted movement of the pendulum relative to the enclosure; a plurality of optical fibers, one end of each of the plurality of optical fibers coupled to an optical receiver, another end of each of the plurality of optical fibers disposed such that light emitted by a light source that passes through the opening of the pendulum can enter one or more of the plurality of optical fibers and be transmitted to the optical receiver, the optical receiver for converting light transmitted by the one or more of the plurality of optical fibers into data signals; and a computer system in communication with the optical receiver, the computer system for receiving data signals transmitted from the optical receiver and determining the position of the pendulum relative to the enclosure.

According to another aspect of the present invention, there is provided a method for leveling an object comprising: providing a pendulum disposed within an enclosure, the pendulum pivotally coupled to the enclosure for enabling pivoted movement of the pendulum relative to the enclosure, the pendulum having an opening through which light can pass to create patterns of light that vary in response to the pivoted movement of the pendulum relative to the enclosure; providing a plurality of optical fibers, one end of each of the plurality of optical fibers coupled to an optical receiver, another end of each of the plurality of optical fibers disposed such that light emitted by a light source that passes through the opening of the pendulum can enter one or more of the plurality of optical fibers and be transmitted to the optical receiver; coupling the enclosure to an object to be leveled; receiving at the optical receiver light emitted by a light source that has passed through the opening of the pendulum; converting the received light into data signals with the optical receiver; transmitting the data signals from the optical receiver to a computer system; and determining with the computer system the position of the pendulum relative to the enclosure.

### BRIEF DESCRIPTION OF THE SEVERAL VIEWS OF THE DRAWINGS

FIG. 1 is block diagram of a leveling system, including a side elevation view of a leveling unit, in accordance with an embodiment of the present invention.

FIG. 2 is a partially exploded perspective view of the leveling unit of FIG. 1.

FIGS. 3A through 3C are side elevation views of certain components of the leveling unit of FIG. 1, illustrating optical detection of level and non-level conditions in accordance with an embodiment of the present invention.

FIG. 4 illustrates deployment of the leveling unit of FIG. 1 on a mainframe computer system in accordance with an embodiment of the present invention.

FIG. 5 is a block diagram of internal and external components of the computer system of FIG. 1.

### DETAILED DESCRIPTION

Briefly, one aspect of the present invention discloses a leveling system to help ensure that a mainframe computer system is level. A pendulum is disposed within an enclosure. The enclosure can be integral to the mainframe chassis, for example, or can be temporarily attached at an appropriate location. The pendulum has an opening through which light can pass. A light source provides light that passes through the opening, creating a light pattern that varies with pivoted movement of the pendulum relative to the enclosure in response to gravity. A plurality of optical fibers transmit the light pattern to an optical receiver, which converts the light into data signals. A computer system receives the data signals from the optical receiver and determines the position of the pendulum relative to the disclosure, which the computer system uses to determine whether the mainframe chassis is level. Embodiments of the present invention can be utilized, for example, during installation of mainframe computer systems to ensure that chassis are properly leveled. Further, embodiments of the present invention can be utilized as a remote monitoring tool to alert service personnel of improper leveling conditions that might occur post-installation.

Embodiments of the present invention will now be described in detail with reference to the accompanying drawings. It is to be understood that the disclosed embodiments are merely illustrative of potential embodiments of the present invention and may take various forms. In addition, each of the examples given in connection with the various embodiments is intended to be illustrative, and not restrictive. Further, the figures are not necessarily to scale, and elements and features can have different dimensions than those depicted in the figures. Therefore, specific structural and functional details disclosed herein are not to be interpreted as limiting, but merely as a representative basis for teaching one skilled in the art to variously employ the present invention.

References in the specification to “an exemplary embodiment,” “other embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

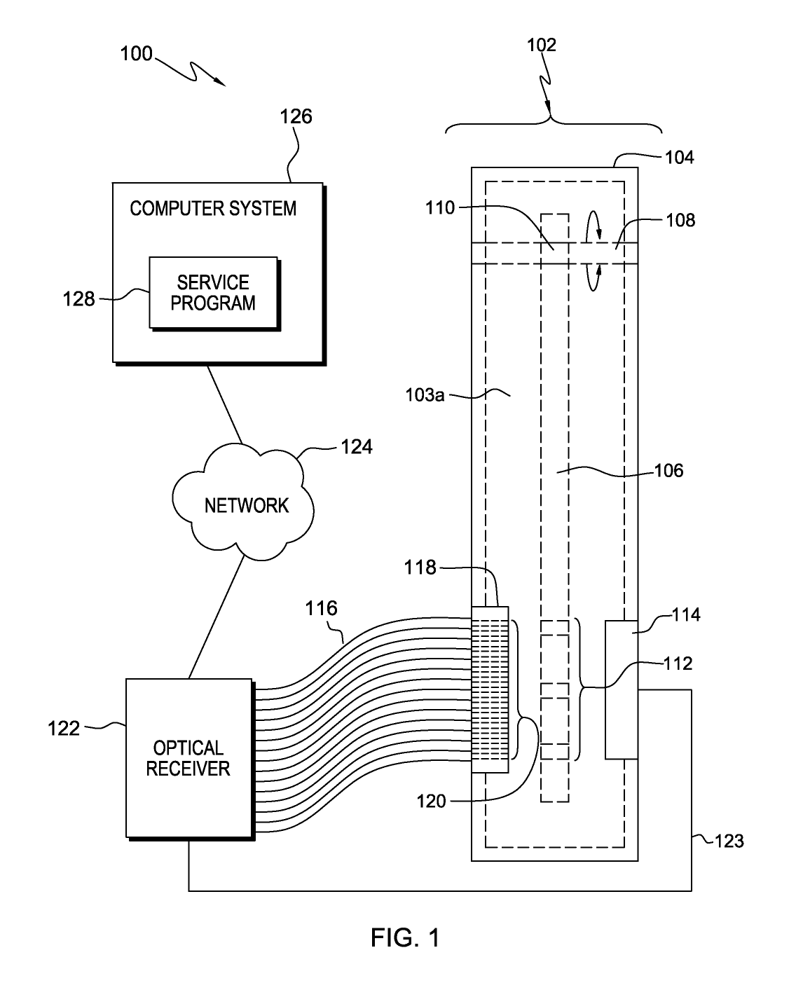

FIG. 1 is block diagram of a leveling system 100, including a side elevation view of a leveling unit 102, in accordance with an embodiment of the present invention. Leveling unit 102 includes an enclosure 104, within which a pendulum 106 is disposed. In this exemplary embodiment, enclosure 104 has a rectangular shape, and face 103a of enclosure 104 is shown. In general, enclosure 104 can be of any shape desired for a particular application. Further, an additional enclosing structure (not shown) can be utilized to enclose leveling unit 102 such that leveling unit 102 can be deployed in a desired environment, such as on surfaces of a variety of objects or devices.

Pendulum 106 is pivotally coupled to enclosure 104 via a rod 108 which extends through pendulum 106 to enable pivoted movement of pendulum 106 relative to enclosure 104 (i.e., rotation about pivot point 110). Pendulum 106 includes an opening 112 through which light generated by a light source 114 can pass to create patterns of light that vary in response to the pivoted movement of pendulum 106 relative to enclosure 104. As discussed later in this specification, embodiments of the present invention utilize these varying light patterns to determine whether leveling unit 102, or a device to which leveling unit 102 is attached, is level.

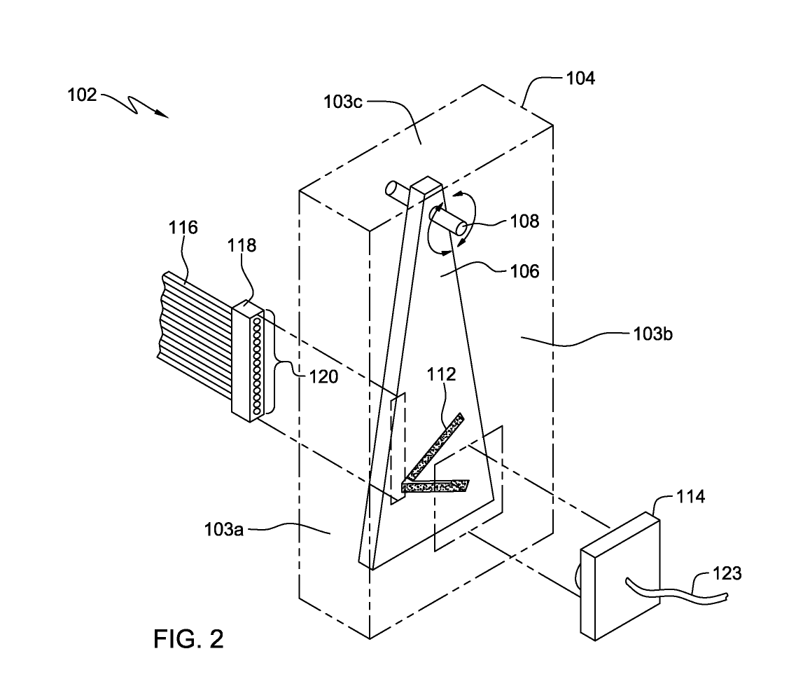

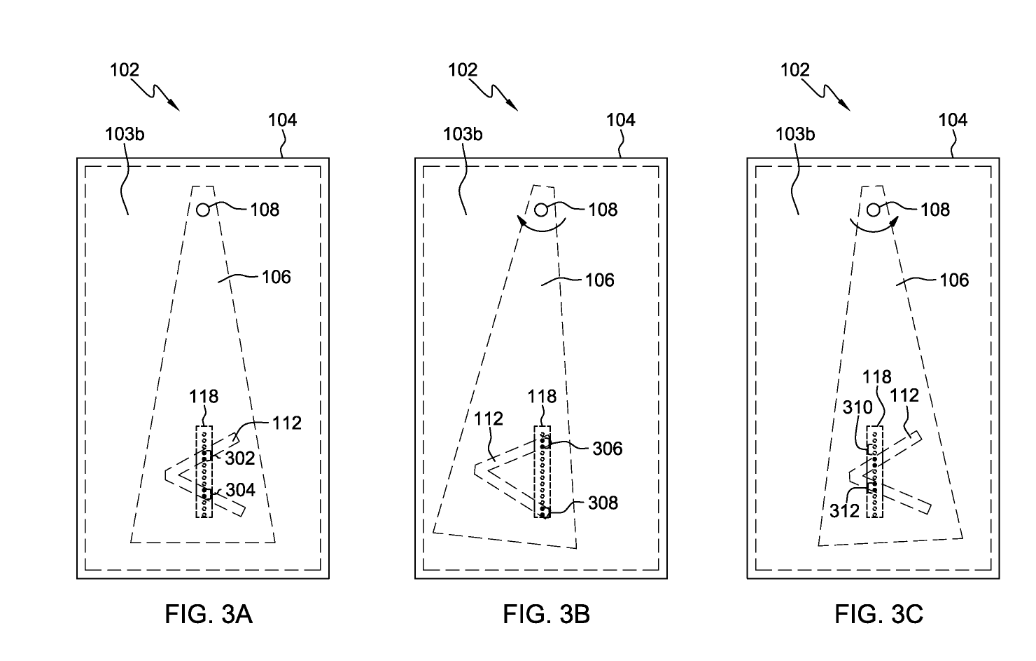

In this exemplary embodiment, opening 112 includes two slots that intersect to form an angle that is greater or less than one hundred and eighty degrees. That is, opening 112 has a “V”-shape, which can be more easily seen in FIG. 2 and FIGS. 3A through 3C. In general, opening 112 can be of any shape or combinations of shapes that create varying light patterns in response to the pivoted movement of pendulum 106 relative to enclosure 104. Similarly, opening 112 can include one continuous opening (e.g., the two intersecting slots of this exemplary embodiment or a single slot), or combinations of discontinuous openings (e.g., two parallel slots).

Light source 114 is coupled to enclosure 104. Light source 114 is positioned such that light emitted by light source 114 can pass, at least in part, through opening 112 to create light patterns that vary in response to the pivoted movement of pendulum 106 relative to enclosure 104 and light source 114. In this exemplary embodiment, light source 114 is implemented with one or more light emitting diodes (LEDs). In general, light source 114 can be implemented with any suitable light source, including, for example, incandescent light bulbs.

A plurality of optical fibers 116 are utilized to transmit to an optical receiver 122 light emitted by light source 114 that passes through opening 112. In this exemplary embodiment, an optical fiber guide 118 is coupled to enclosure 104 and secures in place one end of each of the plurality of optical fibers 116 in a linear array. The end of each of the plurality of optical fibers 116 that is secured by optical fiber guide 118 is disposed (shown at 120) such that light emitted by light source 114 that passes through opening 112 can enter one or more of the plurality of optical fibers 116 depending on the pivoted movement of pendulum 106 relative to enclosure 104 and light source 114, as illustrated and discussed in greater detail with regard to FIGS. 3A through 3C.

The opposite end of each of the plurality of optical fibers 116 is coupled to optical receiver 122. Optical receiver 122 converts light transmitted by the plurality of optical fibers 116 into data signals, which are in turn transmitted to computer system 126 via network 124. Optical receiver 122 also provides power to light source 114 through power connection 123. In this exemplary embodiment, optical receiver 122 includes a separate photodetector for each of the plurality of optical fibers 116 such that optical receiver 122 can convert light transmitted by each of the plurality of optical fibers 116 into data signals on an individual basis. For example, if optical receiver 122 receives light transmitted by one or more subsets of the plurality of optical fibers 116, optical receiver 122 can convert the light into data signals representative of an “on” state for those subsets of optical fibers. Accordingly, optical receiver 122, in conjunction with the plurality of optical fibers 116, can detect a light pattern as a particular combination of the one or more subsets of the plurality of optical fibers 116 that have transmitted light emitted by light source 114, and optical receiver 122 can convert that light pattern into data signals that are transmitted to computer system 126 via network 124.

Network 124 can be, for example, a local area network (LAN), a wide area network (WAN) such as the Internet, or a combination of the two, and include wired, wireless, or fiber optic connections. In general, network 124 can be any combination of connections and protocols that will support communications between computer system 126 and optical receiver 122 in accordance with a desired embodiment of the invention.

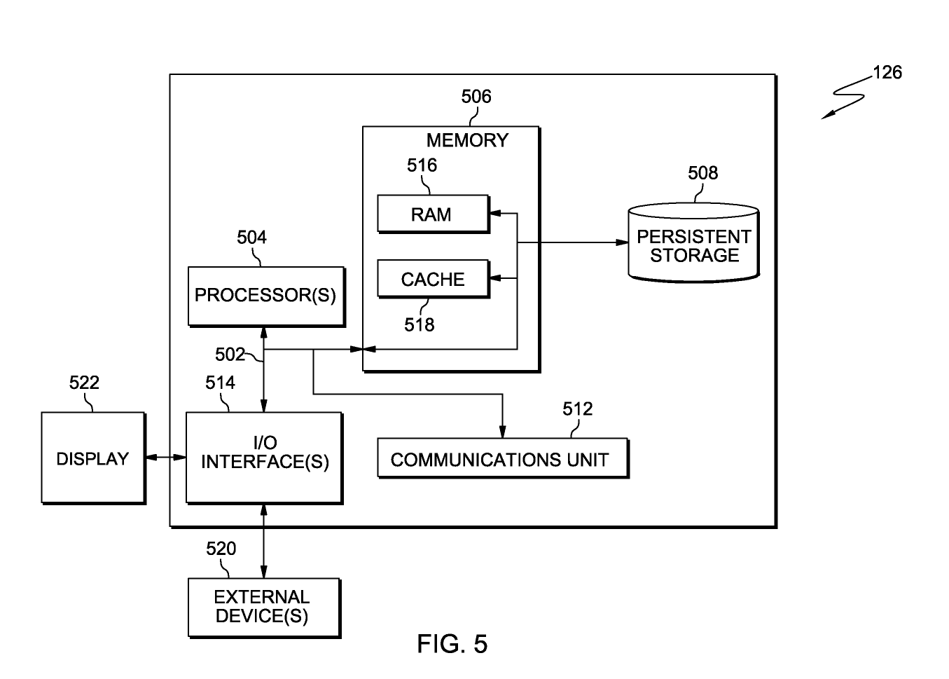

Computer system 126 can be a laptop computer, desktop computer, specialized computer server, or any other computer system known in the art. In general, computer system 126 can be any programmable electronic device as described in further detail with regard to FIG. 5.

Computer system 126 includes service program 128. As discussed in greater detail with regard to FIGS. 3A through 3C, service program 128 receives data signals transmitted by optical receiver 122 and determines whether leveling unit 102, or a device or object to which leveling unit 102 is attached, is level. Service program 128 can display to a user of computer system 126 whether leveling unit 102 is level, including expressing the extent to which leveling unit 102 is in a level or non-level condition as positive and negative degrees and increments of degrees. Service program 128 can be configured to provide alerts to a user of computer system 126 or to one or more other individuals in the event leveling unit 102, or a device to which leveling unit 102 is attached, is in a non-level condition. For example, this embodiment can be useful for remotely monitoring the leveling conditions of mainframe chassis during and after installation.

FIG. 2 is a partially exploded perspective view of leveling unit 102 of FIG. 1. As illustrated, faces 103a, 103b, and 103c of enclosure 104 are shown. In this exemplary embodiment, optical fiber guide 118 secures in place one end of each of the plurality of optical fibers 116 in a linear array. The end of each of the plurality of optical fibers 116 that is secured by optical fiber guide 118 is disposed (shown at 120) opposite to light source 114, with pendulum 106 and opening 112 interposed between optical fiber guide 118 and light source 114. Here, pendulum 106 has a triangular shape and has more mass at the bottom of pendulum 106 (i.e., the end of pendulum 106 opposite rod 108). In general, pendulum 106 can have any suitable shape and mass distribution that enables pivoted movement of pendulum 106 relative to enclosure 104 in response to gravity.

FIGS. 3A through 3C are side elevation views of leveling unit 102 of FIG. 1. FIGS. 3A through 3C show face 103b of enclosure 104 and illustrate optical detection of level and non-level conditions in accordance with an embodiment of the present invention. For illustrative purposes, some elements of leveling unit 102 are not shown in FIGS. 3A through 3C.

Turning now to FIG. 3A, shown is leveling unit 102 in a hypothetical level condition. As previously discussed, the end of each of the plurality of optical fibers 116 that is secured by optical fiber guide 118 is disposed such that light emitted by light source 114 (hidden in this view) that passes through opening 112 can enter one or more of the plurality of optical fibers 116, depending on the pivoted movement of pendulum 106 relative to enclosure 104 in response to gravity. In the hypothetical level condition depicted in FIG. 3A, the position of pendulum 106 relative to enclosure 104 causes subsets 302 and 304 of the plurality of optical fibers to be exposed through opening 112. Accordingly, light emitted by light source 114 that passes through opening 112 creates a particular light pattern, causing light to enter only subsets 302 and 304 of the plurality of optical fibers and be transmitted to optical receiver 122. Optical receiver 122 converts the light transmitted by subsets 302 and 304 of the plurality of optical fibers into data signals that are transmitted to computer system 126 via network 124. Service program 128 receives the data signals and identifies the received pattern of subsets 302 and 304 (i.e., subsets 302 and 304 being in an “on” state).

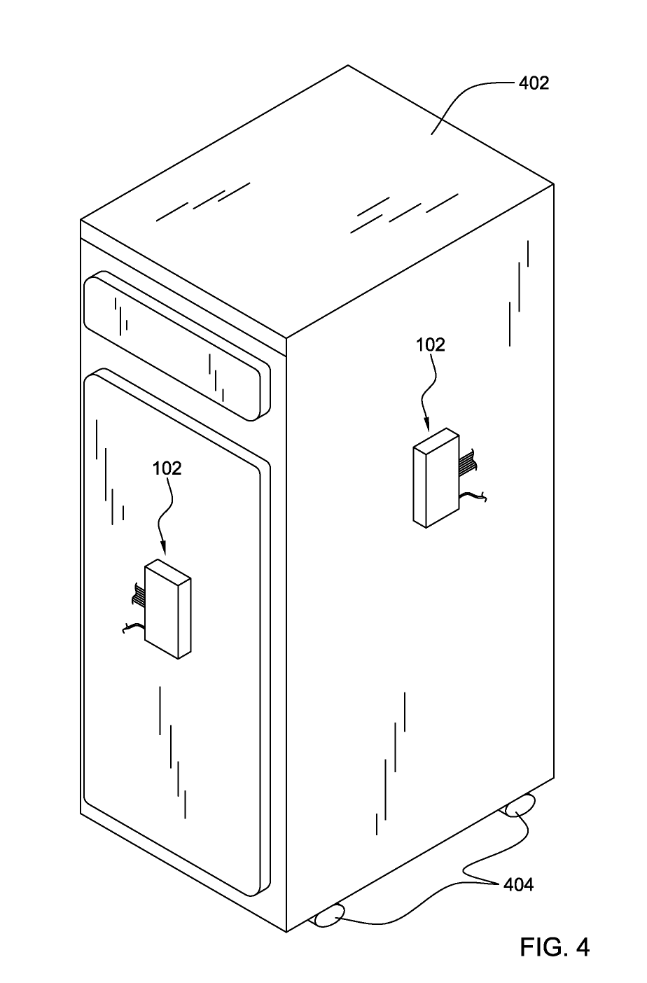

If leveling unit 102 is being calibrated prior to deployment in a particular application, service program 128 stores the received pattern of subsets 302 and 304 as the calibrated level pattern. If leveling unit 102 has already been calibrated, service program 128 compares the received pattern of subsets 302 and 304 to the calibrated level pattern (i.e., in this example, also subsets 302 and 304) and determines that leveling unit 102 is in a level condition. It should be understood that calibrated level patterns can vary depending on how leveling unit 102 is deployed, and obtaining the calibrated level pattern does not require that leveling unit 102 is itself level. For example, if leveling unit 102 is deployed to level a mainframe chassis, multiple leveling units 102 can first be attached to sides of the mainframe chassis (e.g., as illustrated in FIG. 4) or can be integral to the mainframe chassis, but the leveling units 102 need not themselves be in a level position. Instead, the mainframe chassis can then be placed on a level surface, at which time calibrated level patterns can be obtained.

Turning now to FIG. 3B, shown is leveling unit 102 in a hypothetical non-level condition as compared to the hypothetical level condition discussed in FIG. 3A. Pendulum 106 has rotated clockwise about rod 108 (i.e., undergone pivoted movement) relative to enclosure 104. Stated differently, enclosure 104 has rotated counter-clockwise relative to pendulum 106 (i.e., from the perspective of pendulum 106, pendulum 106 may remain substantially stationary due to gravity).

In the hypothetical non-level condition depicted in FIG. 3B, the position of pendulum 106 relative to enclosure 104 causes subsets 306 and 308 of the plurality of optical fibers to be exposed through opening 112. Accordingly, light emitted by light source 114 (not shown) that passes through opening 112 creates a different light pattern than that discussed in FIG. 3A, causing light to enter only subsets 306 and 308 of the plurality of optical fibers and be transmitted to optical receiver 122, which then converts the light into data signals. Service program 128 receives the data signals and identifies the received pattern of subsets 306 and 308. Service program 128 can compare the received pattern of subsets 306 and 308 to the calibrated level pattern of subsets 302 and 304 to determine that leveling unit 102 is in a non-level condition (i.e., the patterns do not match). Further, service program 128 can express the position of pendulum 106 relative to enclosure 104 as degrees and increments of degrees of rotation of pendulum 106 relative to enclosure 104 (i.e., the extent to which leveling unit 102 is not level), as discussed in greater detail later in this specification.

Turning now to FIG. 3C, shown is leveling unit 102 in a hypothetical non-level condition with respect to the hypothetical level condition discussed in FIG. 3A. Pendulum 106 has rotated counter-clockwise about rod 108 relative to enclosure 104. Stated differently, enclosure 104 has rotated clockwise relative to pendulum 106.

In the hypothetical non-level condition depicted in FIG. 3C, the position of pendulum 106 relative to enclosure 104 causes subsets 310 and 312 of the plurality of optical fibers to be exposed through opening 112. Accordingly, light emitted by light source 114 (not shown) that passes through opening 112 creates a different light pattern than that discussed in FIGS. 3A and 3B, causing light to enter only subsets 310 and 312 of the plurality of optical fibers and be transmitted to optical receiver 122, which converts the light into data signals. Service program 128 receives the data signals and identifies the received pattern of subsets 310 and 312. Service program 128 can compare the received pattern of subsets 310 and 312 to the calibrated level pattern of subsets 302 and 304 to determine that leveling unit 102 is in a non-level condition (i.e., the patterns do not match).

In each of these hypothetical leveling conditions, service program 128 can also express the determined position of pendulum 106 relative to enclosure 104 as degrees and increments of degrees of rotation of pendulum 106 relative to enclosure 104. In this exemplary embodiment, during calibration of leveling unit 102, service program 128 can analyze the calibrated level pattern to determine the number of non-transmitting optical fibers in the linear array that are disposed between subsets of optical fibers that transmitted light (e.g., the four optical fibers between subsets 302 and 304 of FIG. 3A that did not transmit light). In the event of a non-level condition, service program 128 can analyze the received pattern to determine the number of non-transmitting optical fibers in the linear array that are disposed between subsets of optical fibers that transmitted light, and compare that value to that of the calibrated level pattern.

In this exemplary embodiment, a greater number of such non-transmitting optical fibers as compared to the calibrated level pattern indicates a greater clockwise deviation from the level position of pendulum 106 relative to enclosure 104 (e.g., FIG. 3B as compared to FIG. 3A); a lesser number of such non-transmitting optical fibers as compared to the calibrated level pattern indicates a greater counter-clockwise deviation from the level position of pendulum 106 relative to enclosure 104 (e.g., FIG. 3C as compared to FIG. 3A). Accordingly, by configuring the quantity and spacing of optical fibers in the linear array (e.g., increasing the density of optical fibers in the linear array), an increase or decrease of a specified number of such non-transmitting optical fibers can represent, for example, an increment of a degree or a fraction of a degree. It will be appreciated by those skilled in the art that various modifications to the illustrated exemplary embodiment are possible. For example, the number of optical fibers disposed in the linear array can be increased or decreased, and subsets of optical fibers that are exposed by opening 112 can, depending on the number of optical fibers disposed in the linear array and the dimensions of opening 112, include varying numbers of optical fibers. Similarly, embodiments of the present invention can be modified to detect different patterns and resolve differences in those patterns to determine the extent to which leveling unit 102, or an object to which leveling unit 102 is attached, is not level.

FIG. 4 illustrates deployment of two leveling units 102 on a mainframe computer chassis 402 in accordance with an embodiment of the present invention. As illustrated, two leveling units 102 are attached to different sides of mainframe computer chassis 402 to achieve level conditions on multiple axes. Leveling units 102 can be attached temporarily or permanently, or leveling units 102 can be integral to mainframe computer chassis 402. Here, mainframe computer chassis 402 includes leveling feet 404. During installation of mainframe computer chassis 402, such as at a data center, mainframe computer chassis 402 can be placed on a level surface and/or leveling feet 404 can be adjusted to achieve a level condition. After achieving a level condition, calibrated level patterns can be obtained as previously discussed, and leveling system 100 can be utilized to monitor the leveling condition of mainframe computer chassis 402.

FIG. 5 is a block diagram of internal and external components of computer system 126 in accordance with an embodiment of the present invention. It should be appreciated that FIG. 5 provides only an illustration of one implementation and does not imply any limitations with regard to the environments in which different embodiments may be implemented. Many modifications to the depicted environment may be made based on design and implementation requirements. Examples of computer systems, environments, and/or configurations that may be represented by FIG. 5 include, but are not limited to, desktop computers, laptop computers, server computers, thin clients, thick clients, multiprocessor systems, microprocessor-based systems, and distributed cloud computing environments that include any of the above systems or devices.

Computer system 126 includes one or more buses 502, which provide for communications between one or more processors 504, memory 506, persistent storage 508, communications unit 512, and one or more input/output (IO) interfaces 514.

Memory 506 and persistent storage 508 are examples of computer-readable tangible storage media. Computer-readable tangible storage media are capable of storing information such as data, program code in functional form, and/or other suitable information on a temporary basis and/or permanent basis. One or more operating systems and service program 128 are stored in persistent storage 508 for execution and/or access by one or more of the respective processors 504 via one or more memories of memory 506.

Memory 506 can include one or more random access memories (RAM) 516, cache memory 518, or any other suitable volatile or non-volatile storage media. Persistent storage 508 can be a magnetic disk storage medium of an internal hard drive. Alternatively, persistent storage 508 can be a semiconductor storage medium such as ROM, EPROM, flash memory or any other computer-readable tangible storage medium that can store a computer program and digital information. The storage media used for persistent storage 508 can also be removable. For example, a removable hard drive can be used for persistent storage 508. Other examples include optical or magnetic disks, thumb drives, or smart cards that are inserted into a drive for transfer onto another storage medium that is also a part of persistent storage 508.

Communications unit 512 provides for communications with optical receiver 122 and other devices and/or computer systems via network 124. The network may comprise, for example, copper wires, optical fibers, wireless transmission, routers, firewalls, switches, gateway computers, and/or edge servers. Communications unit 512 may include network adapters or interfaces such as TCP/IP adapter cards, wireless Wi-Fi interface cards, 3G or 4G wireless interface cards, or interfaces for other wired or wireless communications links. Software and data used to practice embodiments of the present invention can be downloaded from an external computer system via network 124 and communications unit 512 and can be loaded onto persistent storage 508.

One or more I/O interfaces 514 allow for input and output of data with other devices that may be connected to computer system 126. For example, I/O interfaces 514 can provide a connection to one or more external devices 520 and display 522. External devices 520 can include, for example, a keyboard, computer mouse, touch screen, and other human interface devices. External devices 520 can also include portable computer-readable tangible storage media such as, for example, thumb drives, portable optical or magnetic disks, and memory cards. Software and data used to practice embodiments of the present invention can be stored on such portable storage media and can be loaded onto persistent storage 508. External devices 520 can also include optical receiver 122.

Display 522 provides a mechanism to display data to a user and can be, for example, a computer monitor. Alternatively, display 522 can be an incorporated display that also functions as an input device, such as, for example, a display that also functions as a touch screen.

The foregoing description of various embodiments of the present invention has been presented for purposes of illustration and description. It is not intended to be exhaustive nor limit the invention to the precise form disclosed. Many modifications and variations of the present invention are possible. Such modifications and variations that may be apparent to a person skilled in the art of the invention are intended to be included within the scope of the invention as defined by the accompanying claims.

What is claimed is:

1. An optical leveling system, comprising:
a pendulum disposed within an enclosure, the pendulum pivotally coupled to the enclosure for enabling pivoted movement of the pendulum relative to the enclosure, the pendulum having an opening through which light can pass to create patterns of light that vary in response to the pivoted movement of the pendulum relative to the enclosure;
a plurality of optical fibers, one end of each of the plurality of optical fibers coupled to an optical receiver, another end of each of the plurality of optical fibers disposed such that light emitted by a light source that passes through the opening of the pendulum can enter one or more of the plurality of optical fibers and be transmitted to the optical receiver, the optical receiver for converting light transmitted by the one or more of the plurality of optical fibers into data signals; and
a computer system in communication with the optical receiver, the computer system for receiving data signals transmitted from the optical receiver and determining the position of the pendulum relative to the enclosure.

2. The optical leveling system of claim 1, wherein the position of the pendulum relative to the enclosure is expressed as degrees and increments of degrees of rotation of the pendulum relative to the enclosure.

3. The optical leveling system of claim 1, wherein the position of the pendulum relative to the enclosure is expressed as a level or non-level condition.

4. The optical leveling system of claim 1, wherein the data signals are representative of a pattern of one or more of the plurality of optical fibers that transmitted light to the optical receiver.

5. The optical leveling system of claim 1, wherein the opening includes two slots, the two slots intersecting to form an angle that is greater than or less than one hundred and eighty degrees.

6. The optical leveling system of claim 1, wherein the optical receiver includes a plurality of photodetectors, one end of each of the plurality of optical fibers coupled to a separate photodetector of the plurality of photodetectors.

7. The optical leveling system of claim 1, wherein the optical fibers are disposed in a linear array.

8. The optical leveling system of claim 1, further comprising a light source for emitting light that passes, at least in part, through the opening of the pendulum.

9. A method for leveling an object, the method comprising:
providing a pendulum disposed within an enclosure, the pendulum pivotally coupled to the enclosure for enabling pivoted movement of the pendulum relative to the enclosure, the pendulum having an opening through which light can pass to create patterns of light that vary in response to the pivoted movement of the pendulum relative to the enclosure;
providing a plurality of optical fibers, one end of each of the plurality of optical fibers coupled to an optical receiver, another end of each of the plurality of optical fibers disposed such that light emitted by a light source that passes through the opening of the pendulum can enter one or more of the plurality of optical fibers and be transmitted to the optical receiver;
coupling the enclosure to an object to be leveled;
receiving at the optical receiver light emitted by a light source that has passed through the opening of the pendulum;
converting the received light into data signals with the optical receiver;
transmitting the data signals from the optical receiver to a computer system; and
determining with the computer system the position of the pendulum relative to the enclosure.

10. The method of claim 9, further comprising:
expressing with the computer system the position of the pendulum relative to the enclosure as degrees and increments of degrees of rotation of the pendulum relative to the enclosure.

11. The method of claim 9, further comprising:
expressing with the computer system the position of the pendulum relative to the enclosure as a level or non-level condition.

12. The method of claim 9, wherein the data signals are representative of a pattern of one or more of the plurality of optical fibers that transmitted light to the optical receiver.

13. The method of claim 9, wherein the opening includes two slots, the two slots intersecting to form an angle that is greater than or less than one hundred and eighty degrees.

14. The method of claim 9, wherein the optical receiver includes a plurality of photodetectors, one end of each of the plurality of optical fibers coupled to a separate photodetector of the plurality of photodetectors.

15. The method of claim 9, wherein the optical fibers are disposed in a linear array.
